(19) United States
(12) Patent Application Publication
(10) Pub. No.: US 2026/0315915 A1
(43) Pub. Date: Oct. 15, 2026

(54) DYNAMIC ADJUSTMENT OF TRANSMISSION POWER FOR HOSTS IN A GAMING ENVIRONMENT

(71) Applicant: Sony Interactive Entertainment Inc., Tokyo (JP)

(72) Inventors: Edwin FOO, San Mateo, CA (US); Nick DUKELLIS, San Mateo, CA (US)

(21) Appl. No.: 19/177,226

(22) Filed: Apr. 11, 2025

(51) Int. Cl. A63F 13/355

(52) U.S. Cl. CPC A63F 13/355

(57) ABSTRACT

A method, system, and non-transitory computer-readable storage medium for adjusting output power of hosts in a gaming device network that includes hosts and wireless peripheral devices. The gaming device receives status information indicative of network connectivity of the gaming device network based on data from at least (i) a subset of the hosts or (ii) a first wireless peripheral device of the wireless peripheral devices. The gaming device can monitor the network connectivity among the hosts and the wireless peripheral devices. Each wireless peripheral device is wirelessly connected to the gaming device. The gaming device determines an expected degradation in the network connectivity of the gaming device network based on the status information and generates a control output for adjusting an output power level of a host. The control output is transmitted to the host and the output power level of the host is adjusted using the control output.

### TECHNICAL FIELD

This disclosure relates generally to managing transmission power for hosts in a gaming environment.

### BACKGROUND

A gaming environment can be a complex ecosystem with different types of connected devices to a gaming device, including a wide variety of computing devices and peripheral devices, to enhance user experience and interactivity with games. Modern gaming systems often include opportunities to integrate multiple peripherals, for example, virtual reality headsets, motion-sensing controllers, headphones/earbuds, and others that provide immersive gameplay.

### SUMMARY

This specification describes a method, system, and non-transitory, computer-readable medium for adjusting transmission output power of hosts in an electronic gaming device network (also referred to as a “gaming device network” or “gaming network”) for a gaming environment. The gaming device network includes multiple hosts communicatively coupled to an electronic gaming device and to each other, in the gaming environment. The gaming device network also includes wireless peripheral devices configured for wireless communication within the gaming device network. The approach disclosed here includes the electronic gaming device receiving status information indicative of network connectivity of the gaming device network based on data from at least (i) a subset of the multiple hosts or (ii) a first wireless peripheral device of the wireless peripheral devices. The electronic gaming device is configured to monitor the network connectivity, such as between two or more hosts from the multiple hosts, one of the wireless peripheral devices and one of the multiple hosts, a host from the multiple hosts and the electronic gaming device, one of the wireless peripheral devices and the electronic gaming device, or some combination thereof. The wireless peripheral devices are wirelessly connected to the electronic gaming device.

The disclosed approach also includes a determination by the electronic gaming device of an expected degradation in the network connectivity of the gaming device network based on the status information. One example of expected degradation in network connectivity can include round-trip transmission time, e.g., an amount of time from when a message is sent to a device and the reply for the message from the device is received. Expected degradation can include signal metrics such as Received Signal Strength Indicator (RSSI), signal-to-noise ratio (SNR), and signal-to-interference ratio (SIR), among others. Expected degradation can include network congestion characteristics such as packet loss rates, latency, latency patterns, data transfer rates, network errors, jitter, etc. The disclosed approach also includes the electronic gaming device generating a control output for adjusting an output power level of at least one host of the multiple hosts, in response to determining the expected degradation in the network connectivity. The approach also includes transmitting the control output to the at least one host, such as by a first host from the multiple hosts or by the electronic gaming device, adjusting the output power level of the at least one host.

The techniques disclosed herein include determining status information of the gaming device network to identify sources and patterns of interference in the gaming computer network. For example, the gaming device network can be a dense network of wireless peripheral devices and wired hosts connected to the electronic gaming device, each device being capable of facilitating data communication in the network. Each host can be configured to utilize an amount of electric power for the transmission of signals between the peripheral devices and the electronic gaming device, including any hosts that connect the peripheral devices to the electronic gaming device. The cumulative effect of multiple hosts transmitting said signals can inadvertently generate interference in the gaming device network.

The interference can result for a number of reasons, such as signals having different communication protocols with different parameters that when propagated throughout the gaming device network, result in destructive interference in the gaming device network. Said destructive interference can increase latency, reduce bandwidth, and result in the extraneous consumption of computer resources and electrical power due to the electronic gaming device and/or any connected hosts attempting to maintain connectivity in an environment that includes electrical interference. The effects of interference can be further compounded when multiple gaming device networks are in proximity with one another, such that transmission power from hosts in one gaming device network can introduce interference in another gaming device network.

The disclosed technology can utilize predictive models trained to identify interference patterns and their corresponding sources in the gaming device network, allowing a gaming device in the gaming device network to reduce (e.g., prevent) the interference generated. For instance, the disclosed technology can configure the electronic gaming device to generate control outputs that adjust the transmit power of a particular set of hosts because the output transmission power from those hosts is predicted by the model to otherwise generate interference in the gaming device network. The electronic gaming device (and in some implementations, a host controller that is part of the electronic gaming device or external to the electronic gaming device) can be configured to simultaneously reduce (e.g., prevent) interference while maintaining a high-performance, low-latency (e.g., little to no lag) gaming experience for the player. The predictive models can be trained to identify a particular combination of hosts, corresponding configurations for transmission power, and associated wireless devices connected to the host. The electronic gaming device can generate a control output for the particular combination of hosts that accounts for the low-latency demands of a gaming device network while preventing interference from being generated by the combinations of host devices.

In particular, the control output can account interference effects from neighboring gaming computer networks and their associated consoles, hosts, peripheral devices, etc. The disclosed technology provides a control output that considers sources of interferences from non-gaming devices in the gaming environment of the gaming computer network. In some cases, the disclosed technology can identify multiple control outputs corresponding to multiple, different combinations of hosts and their parameters for transmission power. In this way, the disclosed technology can select a control output from the multiple control outputs with a highest likelihood of reducing and/or avoiding interference while maintaining a threshold value for network connectivity, e.g., latency, packet data loss, bandwidth.

As another example, each host can include a respective antenna or antennae and the predictive models can be trained to determine a set of antenna parameters to reduce (e.g., prevent) interference and/or applying interference mitigation techniques. The disclosed technology can allow the electronic gaming device to generate adjustments of antenna parameters that account for the status, signals, and/or parameters of devices in the gaming device network, including the hosts, wireless peripherals, and the electronic gaming device itself.

The disclosed technology can utilize feature data of the gaming environment to identify opportunities to prevent or mitigate interference (including a threshold amount of interference) that would otherwise result in an expected or likelihood of degradation of the gaming device network. Examples of feature data can include data relating to a configuration of a device such as a host, wireless peripheral device, etc., data related to physical actions by the player, e.g., movement or lack thereof, data related to user input provided by the player to the electronic gaming device via the wireless peripheral device, and other types of metrics relating to gameplay of the electronic gaming device. The techniques described herein can be applied to different types of electronic gaming devices (“gaming devices”), such as console devices (“consoles”), mobile devices, personal computers (e.g., laptops, desktops), and other types of devices configured for video gaming.

The disclosed technology can configure the electronic gaming device to identify which hosts to adjust transmission power and apply control outputs that prevent or mitigate the expected degradation of the gaming device network. The dynamic power adjustment techniques include processing different types of data, such as data relating to a configuration of a device, e.g., host, wireless peripheral device, data related to physical actions by the player, e.g., movement or lack thereof, data related to user input provided by the player to the electronic gaming device via the wireless peripheral device, and other types of metrics relating to gameplay of the electronic gaming device. In some instances, the feature data can also include network and performance parameters related a device in the gaming computer network, including latency, ping, battery level, battery capacity, frame rate, and computation load.

In an aspect, the subject matter described in this specification can be embodied in methods performed by an electronic gaming device in a gaming environment. The method for adjusting output power of hosts in a gaming device network for a gaming environment can be for the gaming device network including multiple hosts communicatively coupled to each other and one or more wireless peripheral devices configured for wireless communication within the gaming device network. The method includes receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices. The electronic gaming device is configured to monitor the network connectivity among the multiple hosts and the one or more wireless peripheral devices. Each of the one or more wireless peripheral devices are wirelessly connected to the electronic gaming device. The method includes determining, by the electronic gaming device, an expected degradation in the network connectivity of the gaming device network based on the status information. The method includes, in response to determining the expected degradation in the network connectivity and by the electronic gaming device, generating a control output for adjusting an output power level of at least one host of the multiple hosts. The method includes transmitting, from one of (i) a first host among the multiple hosts or (ii) the electronic gaming device and to the at least one host, the control output, and adjusting, by the at least one host and using the control output, the output power level of the at least one host.

In some implementations, the network connectivity indicates connectivity between (i) two or more hosts from the multiple hosts, (ii) one of the wireless peripheral devices and one of the multiple hosts, (iii) a host from the multiple hosts and the electronic gaming device, or (iv) one of the wireless peripheral devices and the electronic gaming device.

In some implementations, a particular host from the multiple hosts is embedded in the electronic gaming device, and each of the remaining hosts is embedded in a respective wired peripheral device of multiple wired peripheral devices in the gaming environment.

In some implementations, the status information includes one or more of (i) a power output, (ii) a latency, and (iii) bandwidth, for at least one host from the subset of the multiple hosts.

In some implementations, the method includes receiving, from a second electronic gaming device in a second gaming device network for a second gaming environment different than the gaming environment, second status information indicative of network connectivity of the second gaming device network based on data related from at least a subset of (i) second multiple hosts, or (ii) second wireless peripheral devices, in the second gaming device network. The second electronic gaming device can be different from the electronic gaming device and the second electronic gaming device is configured to monitor the network connectivity among the second multiple hosts and the second wireless peripheral devices. The method can include determining, by the electronic gaming device, the expected degradation in the network connectivity of the gaming device network based on the second status information.

In some implementations, the expected degradation in the network connectivity is a value representing (i) latency, (ii) packet loss rate, (iii) bandwidth congestion, or (iv) signal interference.

In some implementations, the electronic gaming device includes a first antenna, each of the multiple hosts includes a respective antenna, and the gaming device network includes communication channels connecting the first antenna of the electronic gaming device the respective antennas of the other hosts in the multiple hosts. The method can include determining, by the electronic gaming device and for a respective antenna of a particular host from the multiple hosts, a value representing connectivity using a first channel from the communication channels connecting the first antenna and the respective antenna. The method can include determining, by the electronic gaming device, that the value representing connectivity falls below a threshold value. The method can include switching from the first channel to a second channel in the communication channels different from the first channel for communication between the first antenna and the respective antenna.

In some implementations, adjusting the output power level of the at least one host includes generating and transmitting a radiation pattern for one or both of (i) the respective antenna for the at least one host, or (ii) the first antenna of the electronic gaming device.

In some implementations, determining the expected degradation in the network connectivity of the gaming device network includes determining an angle indicating direction and a signal strength associated with a source of the expected degradation in the gaming environment.

In some implementations, the electronic gaming device further includes a host controller configured to transmit and receive control outputs between the multiple hosts.

In some implementations, the method includes receiving, at the electronic gaming device, signals including feature data of a gaming session in the gaming environment, wherein the feature data is collected by a peripheral device from the one or more wireless peripheral devices in the gaming environment. The method can include generating the control output based on the feature data from the signals.

In an aspect, the subject matter described in this specification can be embodied in a system. The system can adjust output power of hosts in a gaming device network for a gaming environment. The gaming device network includes multiple hosts communicatively coupled to each other and one or more wireless peripheral devices configured for wireless communication within the gaming device network. The system includes an electronic gaming device including at least one processor and a memory communicatively coupled to the at least one processor, the memory storing instructions which, when executed by the at least one processor, cause the at least one processor to perform operations. The operations include receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices. The electronic gaming device can be configured to monitor the network connectivity among the multiple hosts and the one or more wireless peripheral devices. Each of the one or more wireless peripheral devices are wirelessly connected to the electronic gaming device. The operations can include determining, by the electronic gaming device, an expected degradation in the network connectivity of the gaming device network based on the status information. The operations can include, in response to determining the expected degradation in the network connectivity and by the electronic gaming device, generating a control output for adjusting an output power level of at least one host of the multiple hosts. The operations can include transmitting, from one of (i) a first host among the multiple hosts or (ii) the electronic gaming device and to the at least one host, the control output. The operations can include adjusting, by the at least one host and using the control output, the output power level of the at least one host.

In some implementations, the network connectivity indicates connectivity between (i) two or more hosts from the multiple hosts, (ii) one of the wireless peripheral devices and one of the multiple hosts, (iii) a host from the multiple hosts and the electronic gaming device, or (iv) one of the wireless peripheral devices and the electronic gaming device.

In some implementations, a particular host from the multiple hosts is embedded in the electronic gaming device, and each of the remaining hosts is embedded in a respective wired peripheral device of multiple wired peripheral devices in the gaming environment.

In some implementations, the status information includes one or more of (i) a power output, (ii) a latency, and (iii) bandwidth, for at least one host from the subset of the multiple hosts.

In some implementations, the operations further include receiving, from a second electronic gaming device in a second gaming device network for a second gaming environment different than the gaming environment, second status information indicative of network connectivity of the second gaming device network based on data related from at least a subset of (i) second multiple hosts, or (ii) second wireless peripheral devices, in the second gaming device network. The second electronic gaming device can be different from the electronic gaming device and the second electronic gaming device is configured to monitor the network connectivity among the second multiple hosts and the second wireless peripheral devices. The operations can include determining, by the electronic gaming device, the expected degradation in the network connectivity of the gaming device network based on the second status information.

In some implementations, the expected degradation in the network connectivity can include a value representing (i) latency, (ii) packet loss rate, (iii) bandwidth congestion, or (iv) signal interference.

In some implementations, the electronic gaming device includes a first antenna, each of the multiple hosts includes a respective antenna, the gaming device network includes communication channels connecting the first antenna of the electronic gaming device the respective antennas of the other hosts in the multiple hosts. The operations can include determining, by the electronic gaming device and for a respective antenna of a particular host from the multiple hosts, a value representing connectivity using a first channel from the communication channels connecting the first antenna and the respective antenna. The operations can include determining, by the electronic gaming device, that the value representing connectivity falls below a threshold value. The operations can include switching from the first channel to a second channel in the communication channels different from the first channel for communication between the first antenna and the respective antenna.

In some implementations, adjusting the output power level of the at least one host includes generating and transmitting a radiation pattern for one or both of (i) the respective antenna for the at least one host, or (ii) the first antenna of the electronic gaming device.

In an aspect, the subject matter described in this specification can be embodied in a non-transitory computer-readable storage device storing instructions that when executed by one or more processors of an electronic gaming device cause the one or more processors to perform operations for adjusting output power of hosts in a gaming device network for a gaming environment. The gaming device network includes multiple hosts communicatively coupled to each other and one or more wireless peripheral devices configured for wireless communication within the gaming device network. The operations include receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices. The electronic gaming device is configured to monitor the network connectivity among the multiple hosts and the one or more wireless peripheral devices. Each of the one or more wireless peripheral devices are wirelessly connected to the electronic gaming device. The operations include determining, by the electronic gaming device, an expected degradation in the network connectivity of the gaming device network based on the status information. The operations include, in response to determining the expected degradation in the network connectivity and by the electronic gaming device, generating a control output for adjusting an output power level of at least one host of the multiple hosts. The operations include transmitting, from one of (i) a first host among the multiple hosts or (ii) the electronic gaming device and to the at least one host, the control output. The operations include adjusting, by the at least one host and using the control output, the output power level of the at least one host.

Among other advantages, the disclosed technology can dynamically adjust transmission power of one or more hosts in a gaming device network to reduce latency, packet data loss, and other types of signal loss, such as between the wireless peripheral device and the electronic gaming device. By leveraging predictive techniques for mitigating interference, each host can be more efficiently configured to perform functions for the wireless devices by preventing or mitigating interference, compared to approaches without dynamic power adjustment. These functions can include, but are not limited to, maintaining connectivity between the wireless peripherals and the electronic gaming device, pre-processing data for the electronic gaming device, managing game state in a gaming software application, handling data exchange between the peripheral devices and the electronic gaming device, reducing latency and lag between devices, storing data, event logging, and managing signals for communication (audio, video, text).

For example, the electronic gaming device can be configurated to adjust output power of hosts to maintain or improve connectivity between the electronic gaming device and the peripheral device when the location of the peripheral device changes. For instance, the electronic gaming device can adjust output power of a host based on the location of the host to ensures a higher quality connection (e.g., low latency, faster data transmission rate) with lower interference, compared to a wireless connection with the wireless peripheral. In this way, the gaming device network can achieve the full benefits of mobility and convenience associated with wireless peripherals with the higher data quality/rates and lower interference/latency associated with wired communication.

In particular, the electronic gaming device can itself include a host and leverage locations of other hosts in the gaming environment with respect to locations and connectivity to wireless peripherals. The electronic gaming device can then use the advantage of a reduced signal interference and improve line-of-sight accessibility between the host and the other peripheral devices to achieve an improved (e.g., highest-quality) data communication link to wireless peripherals in the gaming ecosystem, e.g., compared to the other available links.

Reducing interference by adjusting transmit power can also be achieved by the disclosed technology based on the location of the host, as a host can have a general location of usage in close proximity to a player and any wireless peripheral devices in the gaming environment. As such, wireless communication for the wireless peripherals can be hosted by the host closest to the player and the wireless peripheral, and communicated through the wired connection of the closest host that connects to the electronic gaming device, thereby having lower interference from obstructions or other interfering signals compared to wireless communication alone. Another advantage of the disclosed technology includes improving directionality, signal transmission, and signal receipt by antennas included in the hosts. For example, by understanding the relative orientations of the wireless peripheral devices with respect to a host or multiple hosts in the gaming computer network, the disclosed technology can determine an adjustment to the antenna parameters, e.g., directionality for beamforming, to adjust output power and mitigate interference. Determination for adjusting transmission power of hosts can be based on target parameters, such as size, orientation, power configuration, etc., of the antennas, to maintain at least a threshold stability of a wireless communication link between the wireless peripheral and the electronic gaming device.

In another example, the disclosed technology can improve computational efficiency of the electronic gaming device and increase available bandwidth for the electronic gaming device to perform any type of software application. By dynamically adjusting the output power of hosts in the gaming device network to mitigate interference, the electronic gaming device itself can be relieved from computational burdens and save on computational resources like bandwidth and electric power that would be otherwise be consumed in an interference environment. In this way, the electronic gaming device can maintain a reserve of computing bandwidth for additional computing performance for software applications like streaming and communicating with other players.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example environment for dynamic power adjustment among hosts in a gaming computer network.

FIG. 2 is a block diagram of an example host controller for dynamic adjustment of power transmission among hosts in a gaming computer network of a gaming environment.

FIG. 3 is a flow diagram of an example process for dynamic adjustment of power transmission among hosts in a gaming environment.

FIG. 4 is an example computer device for dynamic adjustment of power transmission among hosts in a gaming environment.

Like reference numbers and designations in the various drawings indicate like elements.

### DETAILED DESCRIPTION

A gaming environment (also referred to as a “gaming ecosystem”) can include devices used in a gaming session by one or more users, also referred to as “players.” A gaming ecosystem includes a gaming computer network (also referred to as a “gaming device network” or “gaming network”) with multiple types of gaming devices, such as console devices, mobile devices, personal computers (e.g., laptops, desktops), among others. The gaming network can include computers, peripheral devices, and other types of computer hardware to support a gaming session. Gaming sessions can also include the simultaneous use of multiple types of these devices, and different types of scenarios occurring in the gaming environment can present challenges in maintaining connectivity in the gaming network. The proliferation of video gaming for personal entertainment, content creation, streaming, and professional sports (e.g., eSports) has resulted in gaming network becoming dense, with multiple types of devices connecting to the gaming network using wireless and/or wired communication protocols.

However, the complexity and density of devices in gaming networks for gaming ecosystems can result in poor connectivity, high latency, data packet dropping, and other types of computer-operability problems in the gaming network. The gaming network can become congested due to the number of connected devices, experience a high demand of computational processing to support different types of devices for multiple software applications by the electronic gaming device, and result in electronic interference in the gaming environment. These types of technical computer-problems in the gaming network can drastically reduce the quality of a gaming session for the player due to the poor connectivity, as well as increase the extraneous consumption of computing resources (such as bandwidth and electrical power) to maintain a connection for the electronic gaming device in the gaming network.

A electronic gaming device (such as a console) can run (e.g., execute) different software applications to allow players to play video games, stream video of gameplay footage, provide audio/video communication to players of other electronic gaming devices, perform other types of software applications for gaming. A gaming environment also includes multiple peripheral devices wirelessly connected to the electronic gaming device to collect input from the player to the electronic gaming device, provide feedback from the electronic gaming device to the player, and enhance the player's gaming experience. While wireless peripheral devices allow players to have greater mobility and flexibility, improve ergonomics, and take up less space due to the lack of cables, the wireless nature of the peripheral devices introduce issues in the gaming network, such as signal interference, data packet loss, increased latency, among other issues.

To support the operability of software applications by the electronic gaming device, the gaming network can include host devices (also referred to as “hosts”) that include a wired connection to the electronic gaming device. Having a wired connection between the hosts and the electronic gaming device allows for the electronic gaming device to achieve improved communication with higher data quality (e.g., low latency, faster data transmission rate), compared to a wireless connection. In particular, hosts can be configured by the electronic gaming device to perform tasks that allow or support connectivity between a peripheral device and the electronic gaming device. Examples of tasks include managing game state (e.g., state of the video game a current time), handling data exchange between the peripheral devices and the electronic gaming device, reducing latency and lag between devices, storing data, event logging of events by the player and/or devices, and managing in-game communication (audio, video, text).

In general, the vast number and diversity of devices in the gaming network can increase the complexity of managing traffic in the gaming network and introduce interference from the transmission output power of hosts that are configured to maintain connectivity of devices in the gaming network. However, a host can generate interference when performing computing tasks for the electronic gaming device and can be configured by the electronic gaming device for achieve a target output power based on the tasks to be performed by the host. With the increasing number of wireless peripherals in gaming computer environments, there is also an increase in the number of hosts in the gaming computer environment to support computing tasks and provide interactive gameplay for a player. Each gaming network for a gaming environment can also be referred to as a “bubble,” but the transmission power of the hosts in the bubble can introduce interference.

Furthermore, hosts across multiple gaming environments within proximity of one another can result in overlapping “bubbles” of gaming ecosystems, where interference of one host in a bubble affects connectivity in another bubble. In other words, the density of hosts in each gaming network in a gaming environment can introduce interference within a gaming environment and/or across the multiple gaming environments, resulting in degraded connectivity from the inference. Thus, there is a demand for detecting interference in a gaming network and dynamically adjusting the transmission power of hosts to prevent the effects of interference for devices of the computer network, including latency, signal drop-off, and data packet loss.

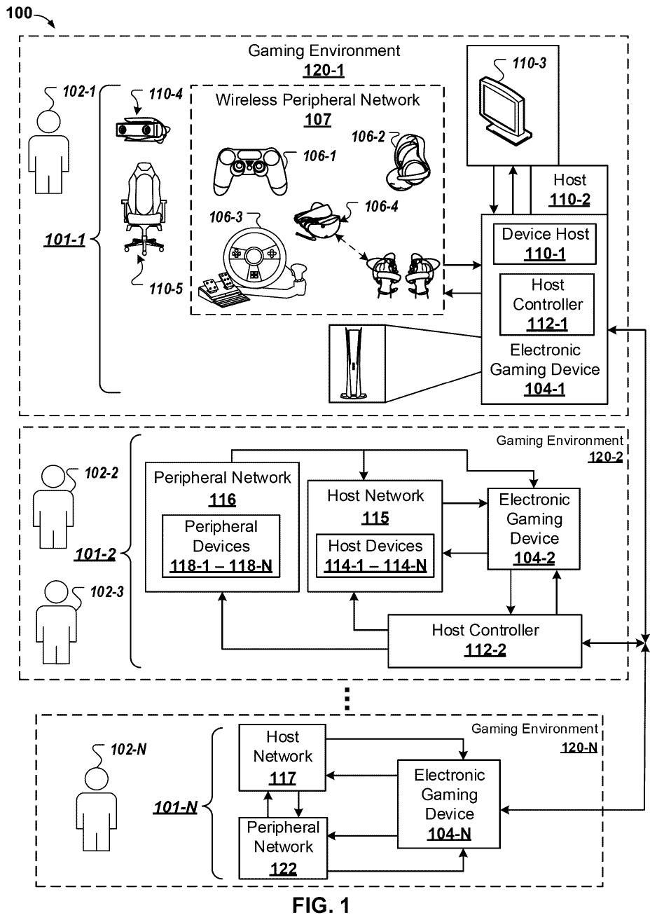

FIG. 1 is a diagram of example an example environment 100 for dynamic power adjustment among hosts in a gaming network 101-1. The environment 100 depicts multiple gaming environments, including gaming environments 120-1, 120-2, and 120-N (collectively “gaming environments 120”), each having a respective gaming network of connected devices, e.g., gaming network 101-1, 101-2, and 101-N (collectively “gaming networks 101”). Although FIG. 1 depicts three gaming environments, the disclosed technology can be applied to any number of gaming networks for any number of devices.

The first gaming environment 120-1 shows a player 102-1 interacting with the gaming network 101-1 for the first gaming environment 120-1. The gaming network of a gaming environment can include any number of electronic gaming devices, peripheral devices, hosts, or some combination thereof. As an example, the gaming network 101-1 for gaming environment 120-1 includes a electronic gaming device 104-1, hosts 110-1 through 110-5 (collectively “hosts 110”) and wireless peripheral devices 106-1 through 106-4 (collectively “wireless peripheral devices 106”). The wireless peripheral devices 106 may be part of a wireless peripheral network 107, which is a subnetwork of the gaming network 101-1.

As depicted in FIG. 1, the electronic gaming device 104-1 (also referred to as “gaming device 104-1”) can include a host, e.g., gaming device host 110-1, also referred to as a “host 110-1.” Although FIG. 1 depicts the gaming device 104-1 as a single gaming device, the gaming device 104-1 can be any number of gaming consoles, mobile gaming devices, laptops, personal computers, computers, or other types of gaming devices or systems. The gaming device 104 can process a user input and/or measurement, e.g., captured by a wireless peripheral device, perform a corresponding action in a gaming software application of the gaming device, and update a display device of the gaming device 104-1 to demonstrate the performance of the corresponding action, among other types of software applications.

For example, the player 102-1 can press buttons of the wireless peripheral device 106-1 to perform in a user interface or gaming application of the gaming device 104-1, e.g., navigating a menu, moving a character in a video game. As another example, the player 102-1 can provide a voice input to the wireless peripheral device 106-2 for transmission to the gaming device 104. One example of a voice input can be a command for a gaming application of the gaming device 104-1, but another example can include communication with another player in a different gaming environment with a different gaming device, e.g., computer, console, handheld gaming device. Another example user input can include a physical action performed by the player 102-1, such as turning the steering wheel and/or pressing a pedal of a pedal system of the wireless peripheral device 106-3, as well as motion captured by a virtual reality (VR) headset and handheld controllers.

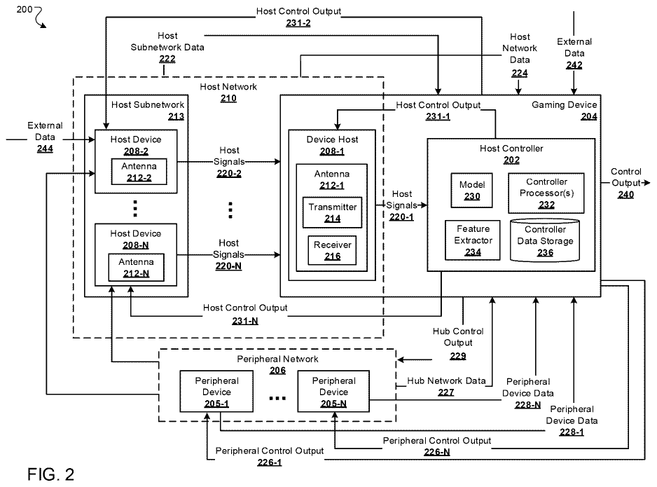

In addition to the device host 110-1, FIG. 1 illustrates the gaming network 101-1 including a host 110-2 as a modular component such as an adapter, dongle, etc., among other hosts 110-3 through 110-5. FIG. 1 depicts host 110-3 as a display device, e.g., monitor, a screen, host 110-4 as a webcam, and host 110-5 as gaming chair. Each of the hosts 110-2 through 110-5 include a respective wired connection to the device host 110-1. Each of the hosts 110 also include a respective antenna that allows for wireless communication with the wireless peripheral devices, described in reference to FIG. 2 below.

The antenna of the host can be configurated to communicate using radio frequency (RF) signals. A host in a gaming environment can include hardware and software to allow enable near-field communication for the host and any peripheral devices. A host can be configured to apply the techniques disclosed herein to achieve improve authenticity, security, and trust between peripherals and the electronic gaming device (such as a console device, a mobile phone, laptop, personal computer, or any type of gaming device).

The gaming device 104-1 includes a host controller 112-1 that can generate control outputs to adjust power output of any host connected to the host controller 112-1. The host controller in a gaming network can be connected, e.g., wired and/or wireless, to another gaming device, another host controller external to a gaming device, a host controller that is an internal component of another gaming device, or some combination thereof. The host controller 112-1 can receive status information relating to the connectivity of the devices in the gaming network and/or the gaming network as a whole. Examples of the status information can include latency, packet loss, jitter, bandwidth (upload/download speeds), signal strength, frequency channel utilization, background network usage, computer processing loads, memory usage, among others. In some implementations, status information can be determined by a wireless peripheral controller, the gaming device, the host controller, or some combination thereof, based on data collected by a device of the gaming computer network, e.g., sensor data or feature data collected by a sensor of a wireless peripheral controller.

The host controller 112-1 can receive data related to the status of the gaming environment 120-1 from a host and/or wireless peripheral device. For example, the host controller 112-1 can wirelessly receive data from a peripheral device, data from a wired host that receives data wirelessly from the peripheral device, or data related to the general status of the gaming network from the wired host. In another example, the device host 110-1 configures the host controller 112-1 to receive and process signals in the gaming environment 120-1 from a wireless peripheral device. The signals can include feature data about a device in the gaming network, e.g., host, peripheral device, such as a current configuration of a device and related device parameters and/or characteristics. The device parameters and/or characteristics can include latency, ping, battery level, battery capacity, frame rate, and computation load, among others. In some cases, signals can also include feature data for at least a subnetwork (or entirety) of the gaming network, such as network and performance parameters relating to the subnetwork.

Feature data can include data related to and/or including the user input provided by the player 102-1 to a wireless peripheral device. For example, the feature data can include data related to engagement between the player and devices with the gaming environment 120-1. In another example, the feature data can include data related to gameplay of the gaming device 104-1, such as performance, metrics, and actions. In some implementations, the feature data can include data related to physical actions by the player 102-1, such as movement from one area of the gaming environment to another area of the gaming environment. In some cases, the feature data can characterize a lack of physical action by the player 102-1. In some implementations, the signals can include feature data from multiple wireless peripheral devices.

In some implementations, feature data can include sensor measurements captured by wireless peripheral device. The wireless peripheral device can include one or more sensors, such as motion sensors, optical sensors, infrared sensors, etc., that can collect different types of sensor inputs. For example, the wireless peripheral device can include microphones to collect input audio signals, e.g., from a player and/or the environment of the athlete, including voice commands. As another example, the wireless peripheral device can include a touchpad input to collect tactile inputs from the player. In some implementations, sensor measurements can be collected by analog inputs such as analog thumb sticks for a wireless controller, e.g., an amount of force applied by the player.

The host controller 112-1 of the console 110-1 can be configured to determine, based on the status information and/or the signals including feature data, an expected degradation in the network connectivity of the gaming network. In some cases, the gaming device 104 (e.g., by the device host 110 and/or by hardware processors and data storage storing instructions for the gaming device 104 as described in reference to FIG. 2 below) A host controller in a gaming computer network can train and apply predictive models to determine interference patterns and sources of interference in the gaming network. In some cases, the host controller can determine an interference pattern resulting from transmission power of hosts in another gaming computer network different than the gaming environment for the host controller. The host controller 112-1 can generate control outputs, e.g., by directly generating control outputs or configure the gaming device 104-1 to generate the control outputs. The control outputs can adjust the transmit power of a particular set of hosts to prevent the interference from being generated and/or mitigate interference within a threshold amount, while maintaining a target set of parameters for the gaming network and devices within the network, e.g., latency, bandwidth, packet loss rate. Patterns of interference can be generated from a set or combination of hosts but can also include particular configurations for host device and/or peripheral devices. Further description of the predictive models and control outputs are described in reference to FIG. 2 below.

The host controller 112-1 for the gaming device 104-1 can receive status information collected by hosts, peripheral devices, and gaming devices from gaming networks other than the gaming network that the host controller 112-1 is part of, e.g., gaming networks 101-2 and 101-N of gaming environments 120-2 and 120-N, respectively. For example, and as depicted in FIG. 1, each of the host controllers in each of the gaming environments can be coupled to one another allow. Coupling the host controllers to each other, e.g., wireless and/or wired connectivity between the host controllers, can allow for the transmission of status information between gaming environments. Each host controller of each gaming environment can detect interference within the gaming environment for the respective host but can also detect interference in other gaming environments.

In some implementations, the host controller 112-1 can be an external device in the gaming network that is coupled to the gaming device 104-1. For example, the second gaming environment 120-2 includes a second gaming network 101-2 with its own hosts and wireless peripheral devices, as well as its own gaming device 104-2. The gaming device 104-2 is coupled to a host controller 112-2 that is separate and external to the gaming device 104-2, in contrast to the host-controller 112-1 being part of the gaming device 104-1 in the gaming computer environment 120-1.

Referring to the gaming environment 120-2, the gaming network 101-2 includes a peripheral network 116 of peripheral devices 118-1 through 118-N (collectively “peripheral devices 118”), e.g., similar to the wireless peripheral network 107 of the gaming network 101-1. The gaming network 101-2 can also include host devices 114-1 through 114-N (collectively “host devices 114”), e.g., similar to the hosts 110 of the gaming network 101-1. The host devices 114 be referred to as a “host network,” as a subnetwork of the gaming network 101-2 depicted in FIG. 1 as “host network 115.” Each host in the host network 115 can have a wired connection to the gaming device 104-2 and can be configured to manage or “host” communication signals between peripherals in the peripheral network 116 and the gaming device 104-2.

In contrast to the first gaming environment 102-1 having a single player 102-1, FIG. 1 depicts the second gaming environment 102-2 having multiple players, e.g., player 102-2 and player 102-3. In some implementations, subsets of the peripheral network 116 (e.g., a subset of peripheral devices 118) can be associated with each player in the gaming environment. The host controller 112-2 can adjust the output power of host devices 114 in the host network 115 to balance power loads so that connectivity signals for a subset of peripheral devices 118 associated with one player, e.g., player 102-2, do not experience more degradation than the connectivity signals for another subset of peripheral devices 118 associated with a different player, e.g., player 102-3. The host controller 112-2 can promote fairness in gameplay between players by providing similar connectivity among different subsets of peripheral devices, e.g., each subset experiencing substantially similar amounts of latency, data packet loss, and other types of signal/network degradation.

In some implementations, a gaming device may not include a host controller but can be controlled by the host controller from another gaming network. For example, the gaming network 101-N for the gaming environment 120-N may not include a host controller, and the output transmission power of hosts in the gaming network 101-N can be adjusted by control outputs, e.g., signals, instructions, from another host controller of another gaming environment.

A gaming device in a gaming environment, such as gaming device 104-1 for gaming network 101-1, can include hardware processors in data communication with memory. Examples of such processors can include one or more central processing units (CPU), one or more graphics processing units (GPU), one or more application-specific integrated circuits (ASICs), one or more digital signal processors (DSPs), among other types of processors. The hardware processors for a gaming device can include input/output interfaces configurable to connect to one or other devices, such as the hosts and the wireless peripheral devices in the gaming network for gaming device. The gaming device can be configured for data communication with one or more servers, e.g., cloud-based servers, through one or more wired or wireless communication networks, such as a cellular communication network, local area network (LAN), wide area network (WAN) such as the Internet, wireless LAN (WLAN), or other type of communication network.

Wireless peripheral devices can generally be devices which facilitate interaction between the player and the gaming device, among other devices in a gaming environment. The wireless peripheral devices can be configurable to connect through respective data communication channels to the gaming device. The data communication channels can be wireless data communication channels, e.g., also referred to as “wireless data communication links.” In some implementations, wireless peripheral devices can be configurable to connect to one or more other wireless peripheral devices through respective data communication channels. Wireless data communication channels can be, for example, using Bluetooth, Wi-Fi, Zigbee, infrared, or another wireless communication protocol. Other examples of wireless peripheral devices can include, for example, audio peripherals such as speakers, headphones, headsets, microphones, earbuds, and the like. Wireless peripheral devices can include, for example, game controllers such as gaming racing wheels and pedals, flight simulator controls, joysticks, handheld controllers, and the like. Other examples of wireless peripheral devices can include computing peripherals such as keyboards, mice, and the like. Examples can also include virtual reality (VR) and augmented reality (AR) components such as VR headsets, goggles, handheld controllers, gloves, smart environments, wearable devices, and the like. Wireless peripheral devices can include image and video capture devices, such as web cameras, motion capture sensors, and the like.

Wireless peripheral devices can include external data storage, for example, external hard drives, memory cards, memory card readers, and the like. Peripheral devices can include wireless communication hubs, for example, wireless network hubs, mesh network components, and the like. In some cases, wireless peripheral devices can include music and rhythm peripherals, for example, interactive musical instruments, microphones, dance interactive components, and the like. Wireless peripheral devices can include hybrid devices, for example, handheld controllers including a display device.

Although FIG. 1 depicts an example display host 110-3 as a display device, gaming environments can include any kind of display device. Examples of displays include, a monitor, television, projector, or otherwise. The display host, e.g., display host 110-3, can be configured for data communication with a gaming device, e.g., gaming device 104-1 and relay audio/visual information from the gaming device. In some implementations, the gaming device can be in data communication with two or more displays, for example, a monitor and a projected display by a projector onto a screen. Displays can be configured to receive and transmit information through a data communication channel to the gaming system. In some instances, the display is configured to receive input from a user, e.g., through a touch screen, by motion sensor/detector, or the like, and provide input to the gaming system. In some implementations, a display is an integrated component of a gaming device, for example, where the display is an integrated component within a form factor of the gaming system. In some implementations, the gaming environment can include a display configured as a wireless peripheral device, rather than a wired host.

FIG. 2 is a block diagram 200 of an example host controller for dynamic adjustment of power transmission among hosts in a gaming network of a gaming environment. Referring to the gaming device 204, the host controller 202 includes a model 230, controller hardware processors 232 (“hardware processors 232”), controller data storage 236, and a feature extractor 234. The block diagram 200 shows the gaming device 204 having a device host 208-1 and a host controller 202, similar to the host 110-1 and host controller 112-1, respectively, from the gaming environment 120-1 described in reference to FIG. 1 above. Although FIG. 2 depicts the host controller 202 as part of the gaming device 204, the host controller 202 can be external to the gaming device 204, such as the host controller 112-2 relative to console device 104-2 in the gaming environment 120-2, described in reference to FIG. 1 above. Although the block diagram 200 depicts a gaming device 204 having device host 208-1, the gaming device 204 can optionally include a host, e.g., similar to the gaming device 104-N in the gaming environment 120-N.

The block diagram 200 also illustrates a number of host devices 208-2 through 208-N, depicted as a host subnetwork 213 in FIG. 2. The host subnetwork 213 can include any number of hosts. Although FIG. 2 depicts the host subnetwork 213 including hosts 208-2 through 208-N, the host subnetwork 213 can be any subset of hosts in the host network 210, including the device host 208-1. Although FIG. 2 depicts device host 208-1 and host controller 202 as separate components of the gaming device 204, in some examples, device host 208-1 and host controller 202 can part of the same component of the gaming device 204. Each host includes a wired connection to the gaming device 204 and a respective antenna configured for wireless communication with wireless peripheral devices in a gaming computer network.

For example, the device host 208-1 is depicted in FIG. 2 having an antenna 212-1, and the antenna 212-1 further includes a transmitter 214 for wirelessly transmitting data to wireless peripheral devices and a receiver 216 for wirelessly receiving data. Wireless transmission of data between the antenna of a host and the wireless peripheral devices can include signals representing feature data of the gaming environment.

Each host in the host network 210 can include a respective antenna. For example, host device 208-2 includes an antenna 212-2 and host device 208-N includes an antenna 212-N. Each antenna can further include a transmitter, receiver, transceiver, or some combination thereof. Examples of antennas can include omnidirectional antennas, directional antennas, or another type of antenna for wireless communication between the host and wireless peripheral devices. The design of an antenna for a host can be based on a threshold set of performance parameters, such as low latency, low loss, high reliability, and the like, to mitigate or reduce an amount of interference in the gaming computer network. The design considerations for the antenna can include, for example, size, placement, orientation, and power supply for the antenna.

An antenna can be a near-field communication (NFC) antenna designed for short-range communication. For example, coil antennas, dipole antennas, path antennas, or the like. An antenna type can be selected for short-range communication operability. For example, dipole antenna, monopole antennas, path antennas, loop antennas, or the like. An antenna type can depend in part on a frequency of operation, e.g., a frequency band of the data communication. An antenna can be, for example, an omnidirectional antenna, e.g., a patch or microstrip antenna. The antenna can be a directional antenna, e.g., such as a Yagi antenna. Multiple design considerations of the antenna can be selected to yield a wireless data communication channel between the antenna and the one or more other peripheral devices that meets a threshold set of performance requirements, e.g., low latency, low loss, high reliability, and the like.

The host controller 202 can process signals from a device in a gaming computer network, such as hosts and peripheral devices in a gaming network, e.g., receiving data from the host and/or from a wireless peripheral device connected to the host. The signals represent feature data captured by a wireless peripheral device but can also include data captured by a wireless peripheral device connected to a gaming device, e.g., a gaming device that optionally does not include a host. As an example, block diagram 200 depicts a peripheral network 206 of peripheral devices 205-1 through 205-N (collectively “peripheral devices 205”). The peripheral network 206 can be an example of a wireless peripheral network 107, peripheral network 116, and/or a peripheral network 122, as described in reference to FIG. 1 above. The peripheral network (also referred to as a “hub” of peripheral devices) can provide hub network data 227 representing data for at least a subset of the peripheral devices in the peripheral network 206 to the host controller 202.

Each peripheral device in the peripheral network 206 can provide signals to the host controller 202. The signal data can include feature data of a gaming environment in the form of peripheral device data. A peripheral device 205-1 can transmit peripheral device data 228-1 to a host device, including a host device external to the gaming device 204, e.g., host device 208-2. The peripheral device 205-1 can also transmit peripheral device data 228-1 to a host device that is internal (e.g., part of) of the gaming device, e.g., device host 208-1. The peripheral device data can include signals representing feature data generated by the peripheral device. The feature data can be generated based on user inputs provided to the peripheral device but can also be generated based on sensor measurements captured by the peripheral device. In some implementations, a peripheral device can provide raw data, e.g., sensor measurements, for transmit to another device.

Each host in the host network 210 can provide signals, such as data collected by peripheral devices and/or peripheral data processed by the host, to the host controller 202. A host 202-1 can transmit host signals to the host controller 202, such as a host controller 202 that is part of the gaming device 204 shown in FIG. 2 but can also transmit host signals to a host controller that is external to the gaming device 204. In some implementations, the host network 210 can provide host network data 224 representing data for at least a subset of the hosts in the host network 210 to the host controller 202.

A host 208-2 and host 208-N, e.g., external to the device host 208-1 and the gaming device 204, can transmit host signals 220-2 and host signals 220-N, respectively, to the host controller 202. The host signals 220-1, 220-2, . . . 220-N (collectively “host signals 220”) can include signals from wireless peripheral devices connect to one or more hosts but can also include pre-processed data from the host. For example, a host can apply processing techniques to the data collected received from peripheral devices (e.g., user inputs, signals) and generate an intermediate output to provide to the host controller 202. Examples of pre-processing techniques can include generating feature vectors, filtering data/measurements, etc.

The host controller 202 generates a control output 240 for adjusting the output transmission power of a host, e.g., based on signals collected by peripheral devices, hosts, and/or gaming devices in the gaming computer network. For example, the control output 240 can be generated based on host signals 220-1 through 220-N, peripheral device data 228-1 through 228-N, host subnetwork data 222, host network data 224, hub network data 227, or some combination thereof. In some implementations, the host controller 202 can be configured to generate a control output based on signals collected by peripheral devices, hosts, gaming devices, subnetworks, and/or networks from a second gaming computer network different from the gaming computer network for the host controller. For example, the host controller 202 can receive external data 242 from a second gaming environment and generate a control output that accounts based on the external data 242, e.g., instead of or in addition to data collected in the gaming computer environment for the host controller. In some implementations, external data for a second, different gaming computer network can be provided from a host device in the first gaming computer environment for the host controller, such as external data 244.

The host controller 202 can generate a control output for one or more hosts, such as a host control output 231-1 for host 208-1, a host control output 231-2 for host 208-2, and a host control output for host 231-N. The control output for a particular host can indicate parameters for adjusting control of the antenna for the respective host, e.g., to adjust output transmission power of the host. The host controller 202 can determine parameters to configure a host in a way that reduces or mitigates electronic interference in the gaming computer network. In some implementations, the host controller 202 can determine a configuration for antennas of one or more hosts based on target parameters, such as size, orientation, power configuration, etc., of the antennas, to reduce or mitigate interference in the gaming computer network within a threshold level.

In some implementations, the host controller 202 of the gaming device 204 can generate a hub control output 229 for a peripheral network 206, e.g., a control output for at least a subset of the peripheral devices in the peripheral network 206. In some implementations, the host controller 202 can generate a peripheral control output for a corresponding peripheral device. For example, the host controller 202 can generate peripheral control output 226-1 for peripheral device 206-1 and a peripheral control output 226-N for peripheral device 206-N. The peripheral control output for a peripheral device can indicate a signal for wireless communication to the peripheral device, such as an audio signal, video signal, etc.

In some implementations, the host controller establishes multiple frequency channels between antennas of the hosts 208-1 through 208-N. The host controller 202 can determine a host control output to mitigate interference by switching from a first frequency channel to another, different frequency channel among the multiple frequency channels.

The host controller 202 can also be configured to generate a canary waveform for monitoring and tracking patterns of interference in a gaming network. In some cases, the canary waveform can be generated and used to monitor and tracking interference for a particular subset of hosts in the gaming network, e.g., between a host embedded in the gaming device and a host external to the gaming device, between multiple external hosts external to the gaming device and the embedded host of the gaming device, between two or more gaming devices each having a respective embedded host, or between two or more hosts external to a gaming device. Peripheral device(s) and/or the host(s) can be configured to generate a waveform response upon receiving the waveform. The waveform response can include detections of interference from signals captured by peripheral device(s) and/or host(s) to provide to the host controller for processing, such as to generate a control output to for adjusting the transmission power of one or more hosts.

The host controller 202 includes the model 230 and the feature extractor 234 to process signals of feature data from the peripheral devices to determine status information of the gaming environment. The model 230 can generate a control output based on any signals and feature data, and the feature extractor 234 can be configured to pre-process any received data, e.g., to generate feature vectors from signals. In this way, the host controller 202 can determine a control scheme to adjust output power of each host in the gaming computer network, in a way that maintains wireless connection of the peripheral device to the gaming device 204 while reducing or mitigating interference. In some cases, the determination can be based on an adjustment of host transmission power that improves latency, reduces packet loss rate, increases bandwidth of the gaming device 204, or some combination thereof.

The model 230 can be trained to generate control outputs that improve computational efficiency of the gaming network and its associated devices. The parameters of the model 230 can be updated or adjusted based on a computational improvement for the gaming network. As an example, the model 230 can be trained to reduce an optimal adjustment, including a series of adjustments over a time period, for transmission power among multiple hosts that achieves a lowest overall interference in a gaming computer network. In some implementations, the model can be trained to reduce or minimize interference based on characteristics of the gaming environment. For example, the model 230 can be trained to identify patterns, such as combinations of peripheral devices, hosts, and related configurations, that generate interference resulting in an expected degradation of network connectivity. The model 230 can be trained to generate control outputs for devices in the gaming computer network, such as hosts, to reduce effects of interference on network connectivity based on an identified pattern. In some implementations, the model 230 can be trained to detect interference patterns based on different types gaming environments, such as a gaming network for a personal residence compared to a competitive electronic sports (esports) arena. In some instances, the model 230 is trained based on a type of gameplay for the gaming computer network, e.g., casual gameplay or competitive gameplay. As another example, the model 230 can be trained according to usage and performance metrics of gameplay-related software applications, such as software applications for streaming, audio/visual communication, messaging, viewing additional content, etc.

The model 230 can be trained using a variety of training techniques to improve transmission power adjustment of hosts in a gaming computer network, including supervised and unsupervised learning techniques. In some implementations, the model 230 can be trained using hybrid-learning techniques. The parameters or weights of the model 230 can be adjusted based on an analysis of network parameters for the gaming network and previously generated control outputs, e.g., to determine if a control output to adjust output power of a host achieves a target reduction or mitigation of interference. By doing so, the model 230 can improve its accuracy in adjusting transmission power of hosts in the gaming network. In some implementations, the model 230 includes one or more fully or partially connected layers and each of the layers can include one or more parameter values indicating an output of the layers.

The hardware processor 232 may include one or more processors, such as general-purpose processors (e.g., a microprocessor), special-purpose processors (e.g., an application-specific integrated circuit (ASIC) or digital-signal processor (DSP)), programmable-logic devices (e.g., a field programmable gate array (FPGA)), or any other processor components. The hardware processor 232 may carry out one or more instructions using one or more arithmetic, logical, and/or input/output operations. Though the hardware processor 232 is illustrated as a single component, the hardware processor 232 may be integrated in whole or in part with other components of the host controller 202 or other components of the gaming device 204.

The controller data storage 236 may be an example of a non-transitory computer-readable medium that can be configured to store instructions, when executed by the hardware processor 232, cause the host controller 202 to perform several processes for adjusting transmission power of hosts in a gaming computer environment. The host controller 202 may be implemented using a combination of software and hardware. The host controller 202 may, for example, be implemented as one or more hardware processors configured to execute one or more algorithms.

Referring to the antenna of a host, e.g., antennas 212-1 through 212-N, the type and configuration of the antenna(s) can depend in part, for example, on computing demands of the host (and/or any connected peripheral devices), e.g., in addition to the detected amount of interference. In some cases, the type and configuration of antenna can depend in part on form factor of the host, a placement of the antenna within the host, location of the host in the gaming environment, and the like. The type and configuration of the antenna can include directional vs. omnidirectional antenna, a size of antenna, a range of broadcast of the antenna, operating power of the antenna, and the like.

In some implementations, a type and configuration of the antenna is selected based in part on a location of the host including the antenna(s) with respect to the gaming environment. A location of the host within the gaming environment, e.g., with respect to each other gaming device in the gaming environment, can dictate a relative distance, e.g., average range of distances, of the antenna to one or more other peripheral devices in the gaming environment gaming ecosystem and a degree to which the line-of-sight between the antenna and the one or more other peripheral devices of the gaming system is obstructed. For example, a first host, e.g., host 110-1 can have a first location and orientation for the antenna within the first host, and a second host, e.g., host 110-2 can have a second location and orientation for the antenna within the second host.

In some implementations, the peripheral devices, e.g., peripheral device 205-1 through 205-N can be located in close proximity to the user. Examples of such peripheral devices can include, headsets, VR headsets, headphones, wearable devices, and the like. In such cases, the location of the type and configuration of the antenna for the host is selected based in part on a location of the user within the gaming environment. For example, a host can be selected in part on a relative proximity of the peripheral device to a user of the gaming system and a degree to which the line-of-sight, e.g., within a visual range, between the antenna of the host and the user is obstructed. In some examples, the host can be selected for power adjustment based on being within a particular range, e.g., less than 1 meter range of distance, of the user and/or the gaming system, e.g., console device, mobile gaming device, desktop, laptop, etc. In some implementations, the host can be selected for power adjustment based on being within a threshold degree of obstruction, e.g., less than 10%, 5%, 2%, 1% of the signal between the antenna of the host and the user is obstructed.

In some implementations, a type and configuration of an antenna is selected in part based on form factor of the host that includes the antenna. For example, a maximum size of the antenna can be selected in part based on the available space within the form factor of the host, e.g., a maximum size of an antenna within a mouse can be less than a maximum size of an antenna within a keyboard or monitor. In some implementations, a type and configuration of an antenna can depend in part on power requirements and available power supply for the antenna. For example, limitations on available power to operate the antenna can determine a maximum size of the antenna. In general, further distance and/or increased obstruction of line-of-sight between antenna and the one or more other peripheral devices can require increased power from the antenna to maintain a stable, e.g., reliable, wireless data communication channel.

In some implementations, a type and configuration of an antenna is selected based on power demands for the signals of the antenna to maintain at least a threshold connectivity between the host and one or more other peripheral devices. A threshold connectivity can be, for example, a connectivity distance range, a target latency, a target resilience of the connectivity, or the like. For example, a target range for connectivity can be 0-3 meters, e.g., that the connection is maintained for a range of separation between host and peripheral and/or host and gaming device of 0-3 meters. In another example, a threshold connectivity can be defined as a latency of the wireless data communication that is within a threshold performance of a wired connection, e.g., where a difference in performance between the wireless connection and a wired connection is indiscernible by a user. In another example, a threshold connectivity can be defined as a resilience of the connection to external aggressors can be within a threshold performance of another type of wireless connectivity protocol, e.g., Bluetooth, from 3-30 meters.

In some implementations, the host is retained within a form factor of a monitor, e.g., a computer monitor, television, or another type of display in data communication with the gaming system, e.g., console device. The antenna of the host device can be within the monitor, in which the antenna can be a directional antenna or omnidirectional antenna and oriented to transmit/receive a frustum aligned with the plate of the monitor display. The size of the antenna of the host within the monitor can depend on (i) an average distance of the monitor to the one or more other peripheral devices, e.g., peripheral devices located in close proximity to the user, (ii) an average interference or obstruction of the RF signal from the antenna within the form factor of the monitor to the one or more other peripheral devices, (iii) a size of the power supply available to power the antenna, e.g., a power supply of the monitor, or (iv) a combination of any of these.

In some implementations, the host is retained within a form factor of a keyboard, e.g., a wired keyboard, in data communication with the gaming system, e.g., console device. The antenna of the host can be within the keyboard, in which the antenna can be a directional antenna or omnidirectional antenna and oriented to transmit/receive in an arc perpendicular to a top surface, e.g., surface including the keys, of the keyboard. The size of the antenna of the host within the keyboard can depend on (i) an average distance of the keyboard to the one or more other peripheral devices, e.g., peripheral devices located in close proximity to the user, (ii) an average interference or obstruction of the RF signal from the antenna within the form factor of the keyboard to the one or more other peripheral devices, (iii) a size of the power supply available to power the antenna, e.g., a power supply of the keyboard, or (iv) a combination of any of these.

In some implementations, a host can include one or more USB ports and can be configured as a hub for multiple peripheral devices. For example, the host can include a first USB port in data communication with the peripheral device for transmitting control signals to the peripheral device, a second USB port in data communication with the peripheral device for receiving signals from the peripheral device, e.g., signals including feature data of the gaming environment, and one or more additional USB ports. The one or more additional USB ports can be configured to connect to one or more additional peripheral devices through respective data communication channels. In some instances, the one or more additional USB ports can be configured to connect to one or more additional peripheral devices through respective wired data communication channels. The host can be configured to transmit/receive data through wired data communication channel from other hosts and provide/receive the respective data through respective ones of the USB ports to the various connected devices.

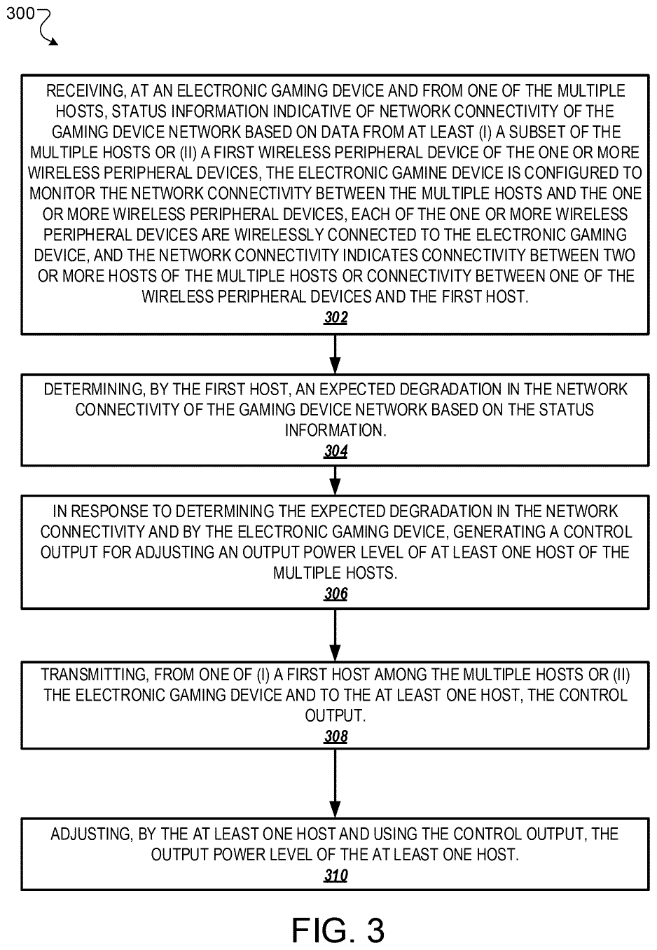

FIG. 3 is a flow diagram of an example process 300 for dynamic adjustment of power transmission among hosts in a gaming environment. The process 300 includes adjusting output power of hosts in a gaming device network, e.g., gaming device networks 101-1 through 101-N, including multiple hosts, e.g., hosts 114-1 through 114-N, connected to each other. The gaming device network also includes one or more wireless peripheral devices, e.g., wireless peripheral devices 118-1 through 118-N, configured for wireless communication within the gaming device network. The process 300 can be performed by an electronic gaming device, e.g., any of electronic gaming devices 104-1 through 104-N, gaming device 204, in a gaming environment. In some implementations, the process 300 can be performed by a host controller, e.g., host controller 112-1 as part of the electronic gaming device or host controller 112-2 external to the electronic gaming device. Examples of hosts can include consoles, mobile gaming devices, personal computers, laptops, link adapters, displays, monitors, webcams, among other types of devices.

The process 300 includes receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices (302). The electronic gaming device is configured to monitor the network connectivity among the multiple hosts and the one or more wireless peripheral devices. Each of the one or more wireless peripheral devices are wirelessly connected to the electronic gaming device.

As an example, the electronic gaming device can apply different techniques to monitor status information, such as ping testing, network telemetry, bandwidth utilization monitoring, and other types of real-time or near-real-time active monitoring. The electronic gaming device can hardware, software, or both configured for monitoring network connectivity. For instance, the electronic gaming device can transmit arbitrary waveforms for network connectivity testing. In some instances, the electronic gaming device can monitor network connectivity by sending data packets, e.g., an echo request to receive a response from a device, to one or more devices, and determine, e.g., by measuring, an amount of time it takes for receive a response from any of the one or more devices.

In some implementations, the status information includes one or more of (i) a power output, (ii) a latency, and (iii) bandwidth, for at least one host from the subset of the multiple hosts. In some implementations, other types of data from the peripheral device can be provided to a host and/or the electronic gaming device (e.g., via a host connected to the peripheral device or from the peripheral device itself). Examples of data related a peripheral device can include data related to or indicative of user inputs, such as button states, e.g., an indication of a button being pressed, a duration of a button press, and axis values, e.g., an application of force or pressure to analog components of a wireless peripheral device. Examples of analog components include analog sticks, triggers, potentiometers, etc., in a wireless peripheral device for variable input values to indicate movement direction, speed, and trigger pull. In some instances, the data related to the peripheral device can be generated from an analog input provided by the user via the wireless peripheral device and converted to a digital signal by the wireless peripheral device. The wireless peripheral device can transmit digital signals representing the status information to the electronic gaming device and/or a host connected to the electronic gaming device.

Other examples of status information can include signals and other forms of data indicating connection status, device identifier, battery level, etc. In some instances, status information can include mapping information, such as a mapping of analog controls, e.g., provided for input by the player to the wireless peripheral device, to digitally coded signals for the electronic gaming device. Status information can also include latency, packet loss, jitter, bandwidth (upload/download speeds), signal strength, frequency channel utilization, background network usage, computer processing loads, memory usage, device information (such as unique identifiers to identify the device).

In some implementations, the network connectivity indicates connectivity between (i) two or more hosts from the multiple hosts, (ii) one of the wireless peripheral devices and one of the multiple hosts, (iii) a host from the multiple hosts and the electronic gaming device, or (iv) one of the wireless peripheral devices and the electronic gaming device. In some implementations, the status information for the network connectivity can also include data related to the connection between two or more devices, such as the type of connection, network protocol, network speed, etc. Other examples information indicative of network connectivity can include data rates, network topology, compatibility of protocols (e.g., security protocols, communication protocols), throughput, etc.

In some implementations, a particular host from the multiple hosts is embedded in the electronic gaming device, and each of the remaining hosts is embedded in a respective wired peripheral device of multiple wired peripheral devices in the gaming environment. Hosts can be devices configured for maintaining and improving connectivity between devices in the gaming computer network. A host can be embedded in a wired peripheral device configured for a different type of application in the gaming computer network than the host, such as a display device, e.g., monitors and televisions, configured to generate a visual representation of content from the electronic gaming device. As another example, a host can be embedded in a wired peripheral device configured to capture data related to the gaming environment and/or the player in the gaming environment.

The wired peripheral device can be a microphone, webcam, etc., that includes sensors to capture audio and/or visual data related to the environment and/or the player, such as the player's movement in the environment. In some instances, the host can be embedded in a gaming chair and include a wired connection to the electronic gaming device to allow for connectivity between wireless peripherals near or in proximity, e.g., relative to the gaming chair, to the electronic gaming device. In this way, the output power of a host can be adjusted to reduce interference between the peripheral devices, hosts, and the electronic gaming device while maintaining connectivity to peripheral devices, such as to provide a seamless gaming experience.

The process 300 includes determining, by the electronic gaming device, an expected degradation in the network connectivity of the gaming device network based on the status information (304). In some implementations, the expected degradation in the network connectivity is a value representing (i) latency, (ii) packet loss rate, (iii) bandwidth congestion, or (iv) signal interference. In some implementations, determining the expected degradation in the network connectivity of the gaming device network includes determining an angle indicating direction and a signal strength associated with a source of the expected degradation in the gaming environment. The expected degradation can include be a predicted value or estimated value based on historical value. In some implementations, a model, e.g., model 230, can be trained to predict expected degradation in the gaming computer network. The expected degradation can be a particular value for a network parameter, such as a threshold, but can also be a range of network parameters, e.g., a range indicating poor connectivity between devices. In some instances, the expected degradation can be a combination of values for different network parameters indicating a likelihood of disconnection, lag, or another type of adverse event for connectivity in the gaming computer network. Examples of parameters (such as metrics) for expected degradation can include RSSI, packet loss rate, latency trends, latency jitter, consistency of latency, signal strength, etc.

The process 300 includes, in response to determining the expected degradation in the network connectivity and by the electronic gaming device, generating a control output for adjusting an output power level of at least one host of the multiple hosts (306). A control output can include data for adjusting the configuration of a host to achieve a target output level. In some instances, the control output to be applied to or by the host can include timing data and instruction data. The timing data can indicate when the control output can be executed and the instruction data can indicate the adjustment itself, and any related data for generating and/or applying the signals to achieve the adjustment. For example, the control output can include a duration for applying the instruction and an instruction for performing the action to adjust the output power of the host.

The process 300 includes transmitting, from one of (i) a first host among the multiple hosts or (ii) the electronic gaming device and to the at least one host, the control output (308). In some implementations, the electronic gaming device transmits the control output to a first host, e.g., a particular host from the multiple hosts, for the first host to transmit to the at least one host. In this way, the control output can be transmitted to a first host that is in proximity of the electronic gaming device and in communication with the at least one host. The first host can transmit the control output to the at least one host, e.g., via a wired or wireless communication, thereby configuring the first host to relay the control output from the electronic gaming device. Relaying the control output by the first host may be preferrable in circumstances where the connectivity between the electronic gaming device and the at least one host is relatively poor (e.g., high latency), e.g., based on the distance between the electronic gaming device and the at least one host. In some cases, relaying the control output by the first host other than the at least one host may be desirable to distribute traffic across multiple hosts, e.g., balancing computational loads and preventing overload of a particular host. Relaying the control output by the first host can provide a back-up communication pathway between the electronic gaming device and the at least one host, such as in cases where a detected interference degrades signal communication between the electronic gaming device and the at least one host but relaying via the first host can allow for the communication with lower delay, lower packet loss rate, etc.

The process 300 includes adjusting, by the at least one host and using the control output, the output power level of the at least one host (310). In some implementations, adjusting the output power level of the at least one host includes generating and transmitting a radiation pattern for one or both of (i) the respective antenna for the at least one host, or (ii) the first antenna of the electronic gaming device. In some implementations, the electronic gaming device further includes a host controller configured to transmit and receive control outputs between the multiple hosts.

In some implementations, the electronic gaming device includes a first antenna, each of the multiple hosts includes a respective antenna, and the gaming device network includes communication channels connecting the first antenna of the electronic gaming device the respective antennas of the other hosts in the multiple hosts. The process 300 can include determining, by the electronic gaming device and for a respective antenna of a particular host from the multiple hosts, a value representing connectivity using a first channel from the communication channels connecting the first antenna and the respective antenna. The process 300 can include determining, by the electronic gaming device, that the value representing connectivity falls below a threshold value. The process 300 can include switching from the first channel to a second channel in the communication channels different from the first channel for communication between the first antenna and the respective antenna.

In some implementations, the process 300 includes receiving, from a second electronic gaming device in a second gaming device network for a second gaming environment different than the gaming environment, second status information indicative of network connectivity of the second gaming device network based on data related from at least a subset of (i) second multiple hosts, or (ii) second wireless peripheral devices, in the second gaming device network. The second electronic gaming device can be different from the electronic gaming device and the second electronic gaming device is configured to monitor the network connectivity among the second multiple hosts and the second wireless peripheral devices. The method can include determining, by the electronic gaming device, the expected degradation in the network connectivity of the gaming device network based on the second status information.

In some implementations, the process 300 includes receiving, at the electronic gaming device, signals including feature data of a gaming session in the gaming environment, wherein the feature data is collected by a peripheral device from the one or more wireless peripheral devices in the gaming environment. The process 300 can include generating the control output based on the feature data from the signals.

In some implementations, generating the control output can include the electronic gaming device generating a set of instructions for the at least one host to perform the control output, and transmitting the set of instructions to the at least one host. In some implementations, the at least one host can be configured by the set of instructions to adjust the output power level of the at least one host. In some implementations, adjusting the output power level can include adjusting operations of the at least one host device to achieve a target power output while maintaining a value for parameter, such as a connectivity parameter for the gaming computer network. In some implementations, the at least one host can be configured to maintain the value for the parameter within a threshold, a range of values, above a value, or another type of threshold.

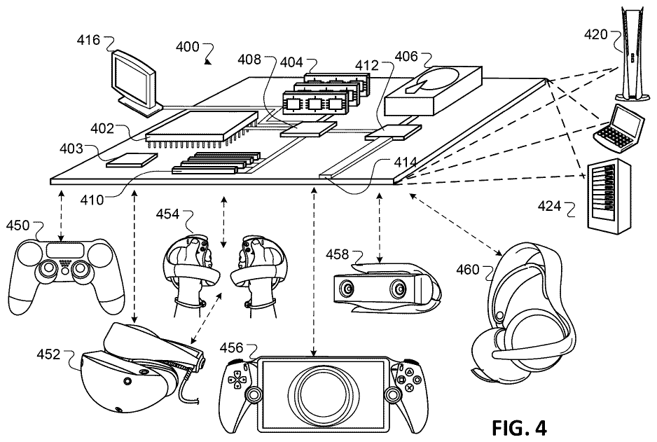

FIG. 4 shows an example of a computing device 400 and associated accessories that can be employed to execute implementations of the present disclosure. The computing device 400 can be a gaming console 420, such as PS5®, PS4®, PS3®, PS2®, etc., or as one or more servers 424 or as a rack within a server. In some implementations, the computing device 400 may be implemented as a personal computer such as a laptop computer 422. In some implementations, the computing device 400 can be implemented as a mobile device such as the connected handheld gaming device 456. In some implementations, a computing device can include one or more of the computing devices 400, and an entire system may be made up of multiple computing devices communicating with each other. For example, a gaming system can include one or more of a gaming console 420, one or more accessories, and a remote platform such as a cloud-based platform implemented on one or more servers 424. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 400 includes some combination of one or more processors or central processing units (CPUs) 402, one or more graphic processing units (GPUs) 403, memory 404, one or more storage devices 406, a high-speed interface 408, and/or a low-speed interface 412. In some implementations, the high-speed interface 408 connects to the memory 404 and multiple high-speed expansion ports 410. In certain implementations, the low-speed interface 412 connects to a low-speed expansion port 414 and the storage device 404. In some implementations, the high-speed interface 408 connects to the storage device 404. Each of the processor 402, the GPU 403, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 includes a volatile memory unit or units. Alternatively, or in addition, the memory 404 can include a non-volatile memory unit or units. The memory 404 may also include another form of a computer-readable medium, such as a magnetic or optical disk. In some implementations, the memory 404 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 406 provides mass storage for the computing device 400. In some implementations, the storage device 406 may be or include a computer-readable medium, such as a hard disk device, an optical disk device, a flash memory, or other similar solid-state memory device, or an array of devices, including devices in a storage area network or other configurations. In some implementations, the storage device 406 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 406 can be configured to support expandable storage via compatible non-volatile memory express (NVMe) SSDs. Instructions can be stored in an information carrier, and when executed by one or more processing devices, such as processor 402, perform one or more methods, such as those described above. The instructions can also be stored by one or more storage devices, such as non-transitory computer-readable or machine-readable mediums, such as the memory 404, the storage device 406, or memory on the processor 402. The instructions can constitute software for providing interactive game play on a user interface such as a graphical user interface (GUI) presented on the display 416.

The high-speed interface 408 generally manages bandwidth-intensive operations for the computing device 400, while the low-speed interface 412 generally manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which accepts various expansion cards. In the implementation, the low-speed interface 412 is coupled to the storage device 406 and the low-speed expansion port 414. The low-speed expansion port 414, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 450 such as a DualSense®, DualShock®, or Access™ controllers for PlayStation® devices, a virtual reality (VR) or augmented reality (AR) headset 452 such as the PS VR2 headset, accessory controllers 454 such as PS VR2 Sense™, a handheld gaming device 456 such as PlayStation Portal®, a camera 458, and/or an earphone/headphone set 460 such as the PULSE Elite™ headset or the Pulse Explore™ earbuds. In some implementations, the computing device 400 includes one or more acoustic transducers, and/or is connected to one or more external acoustic transducers such as one or more speakers associated with the display 416.

The processor 402 can be implemented as a chipset of chips that include separate and multiple analog and digital processors. For example, the processor 402 can be a multi-core processor that supports high-speed processing and enables complex computational tasks, real-time physics simulations, and advanced artificial intelligence (AI) capabilities. In one example, the processor 402 includes at least 8 cores, at least 16 threads, and operates at variable frequencies around 3.5 GHz or more. In some implementations, the processor 402 may be a Complex Instruction Set Computers (CISC) processor, a Reduced Instruction Set Computer (RISC) processor, or a Minimal Instruction Set Computer (MISC) processor.

In some implementations, the GPU 403 includes a custom GPU that supports an advanced architecture such as the RDNA 2 architecture developed by AMD. In certain examples, the GPU 403 includes at least 36 compute units running at speeds of 2 GHz or more, and delivers performance of at least 10 teraflops. The GPU 403 can be configured to support high quality graphics rendering. For example, the GPU 403 can be configured to support hardware-accelerated ray tracing for enhanced realism in lighting and reflections, thereby providing a highly immersive gaming experience.

The computing device 400 can be configured to interact with one or more connected input/output or accessory device in providing the gaming experience. In some implementations, the computing device communicates with a handheld controller 450—e.g., a DualSense®, DualShock®, or Access™ controller for PlayStation® devices—to provide the gaming experience. The controller 450 can feature a high-fidelity haptic feedback system with one or more actuators that simulate a wide range of tactile sensations. In some implementations, the controller 450 includes one or more adaptive triggers that adjust resistance based on in-game actions to provide for a realistic feel.

The ergonomic design of the controller 450 can allow for comfortable use even in long gaming sessions. For example, the controller 450 can include textured grips and an optimized button layout. In some implementations, the controller 450 includes one or more of: integrated motion sensors, a high-resolution touchpad, and a built-in microphone array. The controller 450 includes an array of buttons, joysticks, and other controls that allow a user to interact with the computing device 400 to participate in interactive gameplay presented, for example, on a display device such as the display 416. The controller 450 can be powered by one or more regular or rechargeable batteries and supports both wireless and wired connectivity with the computing device 400, for example, via Bluetooth, WiFi, USB-C, etc., or via a proprietary connection such as PlayStation Link™. In some implementations, the controller 450 includes a light bar and player indicators for visual feedback and customization.

In some implementations, the input/output or accessory device includes a VR/AR headset 452. One example of such a headset is the PlayStation VR2 (PS VR2) headset that is configured to provide an immersive and interactive gaming experience. In some implementations, the headset 452 features dual displays, e.g., organic light emitting device displays or micro-LED displays, with a combined resolution of 4000 4 2080 pixels or higher—thus providing sharp visuals and a wide field of view.

In some implementations, the VR/AR headset 452 includes eye-tracking technology that enables foveated rendering, by focusing on where the user is looking. In some implementations, the headset 452 includes integrated cameras that facilitate tracking head movements without external sensors. In some implementations, the headset includes haptic feedback for tactile sensations and/or one or more acoustic transducers configured to provide a spatial sound effect the user. The headset 452 can include an adjustable headband and cushioned padding, and can be configured to connect to the computing device 400 either over a wireless network (e.g., over a WiFi® or Bluetooth® connection, or a proprietary connection such as PlayStation Link™) or over a wire such as a USB-C cable.

In some implementations, the headset 452 can be configured to work in conjunction with one or more accessory controllers 454 such as the PlayStation VR2 Sense™ controllers. The accessory controllers 454 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 454 can provide a comfortable experience even during extended gameplay. In some implementations, the accessory controllers include one or more integrated sensors (accelerometer, gyroscope, etc.) and/or cameras to provide motion tracking. The accessory controllers 454 can be configured to connect to the computing device 400 and/or the headset 452 over a wireless connection such as WiFi® or Bluetooth®.

In some implementations, the computing device 400 is connected to a handheld gaming device 456 such as the PlayStation Portal®. The handheld gaming device 456 can be configured to stream games and media from the computing device 400 via a wireless connection such as WiFi® or Bluetooth®. The handheld gaming device 456 includes a high-resolution screen that allows users to play games and/or stream media remotely without using the display 416 connected to the computing device 400. This allows the display to be used for other purposes while the computing device 400 facilitates gameplay on the handheld gaming device 456. In some implementations, the handheld gaming device 456 is configured to act as a streaming receiver without running games natively on the device 456 itself. This makes the handheld gaming device 456 a convenient option for playing games run on the computing device 400, while leaving a TV connected to the computing device 400 free to be used for viewing other media. The handheld gaming device 456 can includes buttons and features similar to (or even same as) the controller 450, thus providing for a similar gaming experience as that with the controller 450.

In some implementations, the input/output or accessory devices includes a camera 458 and/or an earphone/headphone set 460 such as the PULSE Elite™ headset or the Pulse Explore™ earbuds. The camera 458 can be used to track user-movements, which in turn can be used as an input to an interactive game being executed on the computing device 400. The earphone/headphone set 460 can be used to provide audio feedback/output to a user from the computing device 400. In some implementations, the earphone/headphone set 460 can include a microphone to receive spoken inputs/instructions that in turn can be used to control an interactive game being executed on the computing device 400.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for adjusting output power of hosts in a gaming device network for a gaming environment, the gaming device network comprising multiple hosts communicatively coupled to each other and one or more wireless peripheral devices configured for wireless communication within the gaming device network, the method comprising:
receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices, wherein the electronic gaming device is configured to monitor the network connectivity among the multiple hosts and the one or more wireless peripheral devices, wherein each of the one or more wireless peripheral devices are wirelessly connected to the electronic gaming device;
determining, by the electronic gaming device, an expected degradation in the network connectivity of the gaming device network based on the status information;
in response to determining the expected degradation in the network connectivity and by the electronic gaming device, generating a control output for adjusting an output power level of at least one host of the multiple hosts;
transmitting, from one of (i) a first host among the multiple hosts or (ii) the electronic gaming device and to the at least one host, the control output; and
adjusting, by the at least one host and using the control output, the output power level of the at least one host.

2. The method of claim 1, wherein the network connectivity indicates connectivity between (i) two or more hosts from the multiple hosts, (ii) one of the wireless peripheral devices and one of the multiple hosts, (iii) a host from the multiple hosts and the electronic gaming device, or (iv) one of the wireless peripheral devices and the electronic gaming device.

3. The method of claim 1, wherein a particular host from the multiple hosts is embedded in the electronic gaming device, and each of the remaining hosts is embedded in a respective wired peripheral device of multiple wired peripheral devices in the gaming environment.

4. The method of claim 1, wherein the status information comprises one or more of (i) a power output, (ii) a latency, and (iii) bandwidth, for at least one host from the subset of the multiple hosts.

5. The method of claim 1, further comprising:
receiving, from a second electronic gaming device in a second gaming device network for a second gaming environment different than the gaming environment, second status information indicative of network connectivity of the second gaming device network based on data related from at least a subset of (i) second multiple hosts, or (ii) second wireless peripheral devices, in the second gaming device network, wherein the second electronic gaming device is different from the electronic gaming device and the second electronic gaming device is configured to monitor the network connectivity among the second multiple hosts and the second wireless peripheral devices; and
determining, by the electronic gaming device, the expected degradation in the network connectivity of the gaming device network based on the second status information.

6. The method of claim 1, wherein the expected degradation in the network connectivity comprises a value representing (i) latency, (ii) packet loss rate, (iii) bandwidth congestion, or (iv) signal interference.

7. The method of claim 1, wherein:
the electronic gaming device comprises a first antenna,
each of the multiple hosts comprises a respective antenna, and
the gaming device network comprises communication channels connecting the first antenna of the electronic gaming device the respective antennas of the other hosts in the multiple hosts.

8. The method of claim 7, further comprising:
determining, by the electronic gaming device and for a respective antenna of a particular host from the multiple hosts, a value representing connectivity using a first channel from the communication channels connecting the first antenna and the respective antenna;
determining, by the electronic gaming device, that the value representing connectivity falls below a threshold value; and
switching from the first channel to a second channel in the communication channels different from the first channel for communication between the first antenna and the respective antenna.

8. The method of claim 7, wherein adjusting the output power level of the at least one host comprises generating and transmitting a radiation pattern for one or both of (i) the respective antenna for the at least one host, or (ii) the first antenna of the electronic gaming device.

9. The method of claim 1, wherein determining the expected degradation in the network connectivity of the gaming device network comprises determining an angle indicating direction and a signal strength associated with a source of the expected degradation in the gaming environment.

10. The method of claim 1, wherein the electronic gaming device further comprises a host controller configured to transmit and receive control outputs between the multiple hosts.

11. The method of claim 1, further comprising:
receiving, at the electronic gaming device, signals comprising feature data of a gaming session in the gaming environment, wherein the feature data is collected by a peripheral device from the one or more wireless peripheral devices in the gaming environment; and
generating the control output based on the feature data from the signals.

12. A system for adjusting output power of hosts in a gaming device network for a gaming environment, the gaming device network comprising multiple hosts communicatively coupled to each other and one or more wireless peripheral devices configured for wireless communication within the gaming device network, the system comprising:
an electronic gaming device comprising at least one processor; and
a memory communicatively coupled to the at least one processor, the memory storing instructions which, when executed by the at least one processor, cause the at least one processor to perform operations comprising:
receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices, wherein the electronic gaming device is configured to monitor the network connectivity among the multiple hosts and the one or more wireless peripheral devices, wherein each of the one or more wireless peripheral devices are wirelessly connected to the electronic gaming device;
determining, by the electronic gaming device, an expected degradation in the network connectivity of the gaming device network based on the status information;
in response to determining the expected degradation in the network connectivity and by the electronic gaming device, generating a control output for adjusting an output power level of at least one host of the multiple hosts;
transmitting, from one of (i) a first host among the multiple hosts or (ii) the electronic gaming device and to the at least one host, the control output; and
adjusting, by the at least one host and using the control output, the output power level of the at least one host.

13. The system of claim 12, wherein the network connectivity indicates connectivity between (i) two or more hosts from the multiple hosts, (ii) one of the wireless peripheral devices and one of the multiple hosts, (iii) a host from the multiple hosts and the electronic gaming device, or (iv) one of the wireless peripheral devices and the electronic gaming device.

14. The system of claim 12, wherein a particular host from the multiple hosts is embedded in the electronic gaming device, and each of the remaining hosts is embedded in a respective wired peripheral device of multiple wired peripheral devices in the gaming environment.

15. The system of claim 12, wherein the status information comprises one or more of (i) a power output, (ii) a latency, and (iii) bandwidth, for at least one host from the subset of the multiple hosts.

16. The system of claim 12, wherein the operations further comprise:
receiving, from a second electronic gaming device in a second gaming device network for a second gaming environment different than the gaming environment, second status information indicative of network connectivity of the second gaming device network based on data related from at least a subset of (i) second multiple hosts, or (ii) second wireless peripheral devices, in the second gaming device network, wherein the second electronic gaming device is different from the electronic gaming device and the second electronic gaming device is configured to monitor the network connectivity among the second multiple hosts and the second wireless peripheral devices; and
determining, by the electronic gaming device, the expected degradation in the network connectivity of the gaming device network based on the second status information.

17. The system of claim 12, wherein the expected degradation in the network connectivity comprises a value representing (i) latency, (ii) packet loss rate, (iii) bandwidth congestion, or (iv) signal interference.

18. The system of claim 12, wherein the electronic gaming device comprises a first antenna, each of the multiple hosts comprises a respective antenna, the gaming device network comprises communication channels connecting the first antenna of the electronic gaming device the respective antennas of the other hosts in the multiple hosts, and wherein the operations further comprise:
determining, by the electronic gaming device and for a respective antenna of a particular host from the multiple hosts, a value representing connectivity using a first channel from the communication channels connecting the first antenna and the respective antenna;
determining, by the electronic gaming device, that the value representing connectivity falls below a threshold value; and
switching from the first channel to a second channel in the communication channels different from the first channel for communication between the first antenna and the respective antenna.

19. The system of claim 18, wherein adjusting the output power level of the at least one host comprises generating and transmitting a radiation pattern for one or both of (i) the respective antenna for the at least one host, or (ii) the first antenna of the electronic gaming device.

20. A non-transitory computer-readable storage device storing instructions that when executed by one or more processors of an electronic gaming device cause the one or more processors to perform operations for adjusting output power of hosts in a gaming device network for a gaming environment, the gaming device network comprising multiple hosts communicatively coupled to each other and one or more wireless peripheral devices configured for wireless communication within the gaming device network, the operations comprising:
receiving, at an electronic gaming device and from one of the multiple hosts, status information indicative of network connectivity of the gaming device network based on data from at least (i) a subset of the multiple hosts or (ii) a first wireless peripheral device of the one or more wireless peripheral devices, wherein the electronic gaming device is configured to monitor the network connectivity among the multiple hosts and the one or more wireless peripheral devices, wherein each of the one or more wireless peripheral devices are wirelessly connected to the electronic gaming device;
determining, by the electronic gaming device, an expected degradation in the network connectivity of the gaming device network based on the status information;
in response to determining the expected degradation in the network connectivity and by the electronic gaming device, generating a control output for adjusting an output power level of at least one host of the multiple hosts;
transmitting, from one of (i) a first host among the multiple hosts or (ii) the electronic gaming device and to the at least one host, the control output; and
adjusting, by the at least one host and using the control output, the output power level of the at least one host.
